(19) United States
(12) Patent Application Publication
(10) Pub. No.: US 2017/0088248 A1
(43) Pub. Date: Mar. 30, 2017

(54) PROFILE FOR CONNECTING A FLOOR STRUCTURE AND SEALING SYSTEM FOR A FLOOR STRUCTURE

(71) Applicant: Airbus Operations GmbH, Hamburg (DE)

(72) Inventors: Gerd STAHL, Wolgast-Mahlzow (DE); Florian MACKE, Lilienthal (DE); Andreas ADAM, Weyhe (DE)

(21) Appl. No.: 15/277,435

(22) Filed: Sep. 27, 2016

(30) Foreign Application Priority Data
Sep. 30, 2015 (DE) 102015116591.0

(51) Int. Cl. B64C 1/18

(52) U.S. Cl. CPC B64C 1/18

(57) ABSTRACT

A profile for connecting a floor structure. The profile comprises a web with a recess along a longitudinal direction of the profile. The web is adapted to reach into a gap in the floor structure in order to provide the connection of the floor structure. At a first end of the web two lips extending in the longitudinal direction of the profile are attached wherein the lips are adapted to prevent a release of the profile from the gap. The disclosure further relates to a sealing system for a floor structure as well as an aircraft with a sealing system and a method for connecting a floor structure.

### CROSS-REFERENCE TO RELATED APPLICATION

This application claims priority to German Patent Application No. 102015116591.0, filed Sep. 30, 2015, which is incorporated herein by reference in its entirety.

### TECHNICAL FIELD

The embodiments described herein relate to constructing floor structures in aircraft. In particular, an embodiment of the invention relates to a profile for connecting a floor structure, a sealing system for a floor structure, an aircraft with a sealing system, and a method for connecting a floor structure.

### BACKGROUND

Floor structures in vehicles, in particular in aircrafts are mounted to the vehicle structure by means of a multitude of connection elements like, for example, screws. This requires a high installation effort, since a large number of screws for assembling the floor plates of the floor structure is used. Such a multitude of screws for the attachment is needed because the floor structure is partially exposed to high loads and stresses during operation of the vehicle. Due to the large number of screws for attaching the floor structure to the vehicle structure, the assembly is time consuming, because usually each screw is tightened individually.

US 2010/0044510 A1 describes a floor structure for a fuselage. The floor structure comprises a multitude of crossbeams, which are connected by struts to the fuselage. The struts receive a force effective in longitudinal direction of the fuselage.

US 2011/0036946 A1 describes a method for equipping an aircraft with a floor. The aircraft comprises a fuselage, which is formed by an inner volume and a board structure. The board structure is attached to the fuselage and configured to receive a floor module.

In addition, other objects, desirable features and characteristics will become apparent from the subsequent summary and detailed description, and the appended claims, taken in conjunction with the accompanying drawings and this background.

### SUMMARY

There may be a need to reduce the effort during assembling of a floor structure.

According to an aspect, a profile for connecting a floor structure is provided. The profile, which is for example a plastic profile, comprises a web with a recess extending along a longitudinal direction of the profile. Thereby the web is configured to engage with or be embedded into the floor structure to thereby establish the connection of the floor structure. Two elastic lips extend at a first end of the web in the longitudinal direction of the profile. The lips are configured to prevent a release of the profile from the gap.

With such a profile it is possible to provide a floor structure by connecting floor plates and thereby reduce the effort for installing the floor plates. At the same time, an improved sealing of the gap between the floor plates can be achieved. In other words, a reduced number of fastening means like screws for assembling the floor structure is needed.

For example, the floor structure is a floor structure of a vehicle. Preferably the floor structure is a floor structure of an aircraft. The floor structure may comprise multiple floor plates, multiple connection elements, as well as the profile itself. The floor plates may together represent, for example, the floor structure of the floor of a passenger cabin of a passenger plane. Likewise, such floor structures may be used in the cargo section of a passenger plane or freight plane. The profile, which is preferably a plastic profile, is inserted during assembly between adjacent floor plates, so as to thereby connect the floor plates with each other. In particular, the profile is inserted into the gap in such a manner that the lips located at the first end of the web are pressed together while the profile is inserted into the gap. When the profile has been pushed by a certain distance through the gap, the lips restore to their original shape relative to the web or more specifically are forced apart due to their elasticity. Subsequently, a fastening means, such as a locking bolt, for example, may be inserted into the profile, which additionally presses apart the lips or keeps the lips spaced apart from each other, so that release of the profile is no more possible after assembly or after the joining of the floor structure.

The elastic lips at the first end of the web are, for example, also made of plastic, so that the entire profile is corrosion resistant. Further, by joining the floor structure by means of the profile, a sealing of the gap may be achieved, so that any liquids possibly present in the passenger cabin, cannot pass through the floor structure.

For example, the profile is shaped as a T-profile, the web of which fills the gap after assembly at least partially, and the belt of which, i.e. the cross-piece, forms a part of the floor resulting from the mounting of the floor structure. Thus, the belt in particular represents a partial section of the profile.

The floor plates themselves can be attached by screws to structural elements of the vehicle or the aircraft. Thus, it may be provided that the profile is only used for connecting and/or sealing of the floor structure.

According to an embodiment, the web comprises a foam tape, for example made of an elastomer, for sealing the floor structure. This means that the foam tape may be an elastic foam tape, in particular.

The foam tape may be wound, for example, onto lateral surfaces of the web. For example, the foam tape is wound onto the web, before the profile is embedded into the gap of the floor structure. Thus, a sealing of the gap between the floor plates may be achieved. The foam tape may cover the web along the entire height. In other words, the foam tape is arranged between the lips and the belt of the profile, i.e., between the first end and a second end of the web. The foam tape may contact the lateral surfaces of the floor plates to be joined or connected with each other after assembly of the profile, for example.

According to a further embodiment, the foam tape completely encompasses at least two sides of the web.

These sides or lateral faces of the web form surfaces, which are defined, for example, by the longitudinal direction and by a vertical axis. The vertical axis is, for example, parallel to a central axis of an opening or bore in the belt of the profile, which opening or bore is adapted for receiving a connecting element. However, viewed in a cross-section, the lateral surfaces of the web may also be arranged wedge-shaped with respect to each other. This will be elucidated in more detail in the description of the figures. By fully enclosing or encompassing the two opposite sides of the web by the foam tape, a sealing of the floor structure may be achieved.

According to a further embodiment, the profile comprises in the region of a second end of the web a belt having an opening for receiving a locking bolt.

The profile may also comprise two or a plurality of such openings, in particular. Thus, the profile may be configured to receive a plurality of locking bolts to attach the profile to the floor structure.

The belt is by definition a portion of the profile, which may be a T-profile, in particular. The belt may therefore also be referred to as a flange. Thus, the web and the belt are the main components of the profile in each case. The lips are attached directly to the web and are designed to be flexible. The opening in the belt is, for example, circular, so that a head of the locking bolt can be sunk in the circular opening. The second end of the web forms a junction point of the web and the belt, wherein the first end of the web forms a connection to the two elastic lips.

According to a further embodiment, the opening comprises a circular recess in the belt. Further, the opening has an elongated hole which extends in the longitudinal direction and forms a connection to the recess in the web.

In other words, the opening is formed by different sections, wherein the first section is formed by the circular recess in the belt and the second section is formed by the elongated hole in the web. The elongated hole may also be a part of the recess in the web. In particular, the recess and the elongated hole extend in the longitudinal direction. In addition, a third section may be formed by a free space between the two lips. The circular recess of the belt may be adapted such that a head of the locking bolt may be fully embedded in the belt, and, thus, the entire profile, including the locking bolt, forms a flat surface on the belt. Thus, in the assembled state, the head of the locking bolt is completely positioned in the circular recess and a shaft of the locking bolt is at least partially in the elongated hole and/or in the recess of the web. At one end of such a locking bolt, a thickening or an elongated attachment may be provided, which pushes apart the lips of the profile in the assembled state. This will be explained in more detail in the description of the figures.

According to a further embodiment, the profile has a T-shaped profile and/or is a plastic profile.

In this case, the web and the belt of the profile constitute the two main parts of the profile. The profile is in particular a plastic profile. The plastic is, for example, a polymer. However, other plastics may be used, too. It should be noted, that the profile has a T-shape in a sectional view. In particular, the T-shaped profile extends in the longitudinal direction. By implementation of the profile as a plastic profile an improved corrosion resistance may be achieved.

According to a further embodiment, each of the elastic lips comprises a ring segment shaped profile.

Thereby the lips comprise a ring segment-shaped or curved profile in a sectional view. The end portions of the lips may thereby be rounded. It may be provided that the lips comprise a ring segment with a quarter of the circumference of a complete ring. In other words, the lips are sickle shaped. The lips are each arranged at the first end of the web or in the region of the opposite sides of the web. However, the lips may also be straight or linear and not curved. Further, the lips may comprise locking lugs or barbs. However, in a preferred embodiment, the lips are curved or of a ring-segment shape.

According to a further embodiment, the lips are arranged rotatable about a point at the first end of the web in each case.

This rotatability serves facilitating the assembly, since the lips are pressed together when pushing the profile through the gap in the floor structure and are subsequently pushed apart due to their elasticity, so that the profile adopts its original shape again. Further, an attachment element or a thickening of the locking bolt is arranged between the two lips in the assembled state, which attachment element or thickening presses the lips apart and thereby prevents release of the profile from the floor structure. The axis of rotation of the two lips is, for example, parallel to the longitudinal direction of the profile. The lips are elongated and extend in the longitudinal direction.

According to a further embodiment, in an unloaded state the lips protrude beyond a width of the web with respect to a transverse direction. In other words, the lips are pressed apart due to their elasticity and/or due to the insertion of the locking bolt. The transverse direction is, for example, perpendicular to the vertical axis and perpendicular to the longitudinal direction. In particular, the vertical axis, the longitudinal direction and the transverse direction may form a right-hand system. In a sectional view of the profile, the transverse direction may also be, for example, the main direction of extension of the belt of the profile.

Forcing apart or the lips or forcing them towards each other means in each case that the lips rotate about the point at the first end of the web, however, perform their movement mainly in the transverse direction.

According to another aspect, a seal system for a floor structure is further indicated. The sealing system comprises a first and a second floor plate. Further, the sealing system comprises the above-described profile. The sealing system also comprises a locking bolt for fixing the profile in the floor structure. In an assembled state, the profile is at least partially arranged between the first floor plate and the second floor plate, thereby sealing the floor structure.

The profile is thereby inserted, for example, in a gap of the floor structure, and locked by the locking bolt in such a way that a release of the profile from the gap of the floor structure is prevented. In other words, the locking bolt is inserted during assembly into the opening of the profile and locked by a rotational movement in the profile, wherein, during the rotation, the lips are pressed apart, so as to prevent a release of the profile from the floor structure and out of the gap of the floor structure. Thus, releasing may be achieved only by a rotational movement in the opposite direction, for example, during disassembly, and by a subsequent withdrawal of the locking bolt. This is possible, since the lips are designed elastically and thus always ensure a pushing through of the web, including the lips, through the gap.

In this way, the floor plates of the floor structure are held together or are connected, as well as a sealing of the gap between the floor plates can be achieved. In the first place the profile, however, serves for sealing the floor plates of the floor structure. In a sectional view, the profile may be embedded in such a way in the gap between the two floor plates in an assembled state, that only the web and the belt of the profile are arranged between the two floor plates, however, the two lips protrude in the direction of the vertical axis below the floor plates. In the assembled state, the locking bolt may further be embedded in the profile such that an upper surface of the head of the locking bolt is flush with a surface of the belt, wherein the surface of the belt may be flush with surfaces of the two floor plates. Thus, a flat surface of the floor structure may be provided.

According to an embodiment, the locking bolt comprises an elongated attachment at a first end, which elongated attachment is adapted to push apart the lips in an assembled state of the profile, so as to prevent release of the profile from the two floor plates.

The elongated attachment is, for example, a thickening at the end of the shaft of the locking bolt. In other words, the head and the elongated attachment of the locking bolt can be connected by the shaft. The assembled state defines, for example, that state in which the profile is embedded in the gap between the floor plates, and a surface of the belt is aligned with the surfaces of the floor plates, and at the same time the lips of the profile are forced apart by the elongated attachment of the locking bolt. This is achieved by rotating the locking bolt after inserting the locking bolt into the opening of the profile, so that the elongated attachment or the thickening points in the transverse direction. Release in turn is enabled by a rotational movement of the locking bolt, so that the elongated attachment or the thickening point in longitudinal direction and subsequently, the locking bolt can be pulled out of the profile by movement along the vertical axis. Marker or markers may be provided at the locking bolt, which markers indicate the assembled state of the profile.

According to a further embodiment, the locking bolt comprises a head at a second end, which head is adapted to bear or lay upon a bearing surface of the circular recess when the profile is in the assembled state. In other words, the head of the locking bolt is fully embedded or sunk into the circular opening of the profile in the assembled state. Thus, a surface of the head of the locking bolt and a surface of the belt may be flush with each other. When being viewed in a cross section, the bearing surface of the circular recess forms the beginning of the web of the profile, for example.

According to a further embodiment, a surface of the belt of the profile is aligned with a surface of the first floor plate and a surface of the second floor plate in the assembled state. Further, a top surface of the head of the locking bolt is aligned with a surface of the belt in the assembled state.

Thus, a planar or even surface of the entire floor structure may be achieved, when the profile is installed for connecting the floor plates and the floor structure.

According to another aspect, an aircraft with the above described sealing system is provided.

For example, the aircraft may be an airplane, in particular a commercial airplane. Here, the sealing system is preferably adapted for sealing a floor structure of the airplane.

According to another aspect, a method for connecting a floor structure is further provided. In a step of the method, a positioning of a first floor plate and a second floor plate takes place such that a gap remains between the first floor plate and the second floor plate. In a second step of the method, provision of a profile for connecting a floor structure as described above in a gap between the first floor plate and the second floor plate takes place, such that the floor structure is sealed.

Thus, with the profile according to at least one embodiment not only a joining of the floor structure may be achieved, but also a sealing of the floor structure. The profile may be produced for example by an extrusion process. Thereby, modifications and adaptations of the profile may be made such that cutouts, for example for seat tracks or stiffening elements are provided at various points of the profile. For example, the sealing function is taken by the foam tape. By providing the profile for connecting or for sealing the floor structure, the use of many clip nuts or bolts may be avoided. Further, the application of a corrosion protection may be prevented, since sufficient corrosion resistance may be provided as a result of the configuration of the profile and of the components of the profile in form of a plastic component. The vertical installation, i.e. the insertion of the profile along the vertical axis, may be considered as a clip- and latch mechanism, since the lips engage in the region of the underside of the floor plates, and thus prevent release of the profile from the gap between the floor plates. Due to the contour of the profile, a compensation of possible tolerances between the floor plates may be achieved. For example, the edges of the floor plates may be beveled or chamfered. The profile is fastened by the locking bolt after embedding it into the gap, wherein the profile may be brought in the assembled state by rotation of the locking bolt, for example about a quarter turn. The closed position or the assembled state may be indicated by a marker or a marking. This may be, for example, an arrow positioned at the upper surface of the head of the locking bolt or another geometric shape or sign at the locking bolt and/or at the profile.

The installation procedure of the profile comprises several steps. For example, at first the floor plates may be provided and thereby fastened to a structure of the vehicle or aircraft first by means of screws. Thereafter, the profile which is in particular a plastic profile, may be inserted and locked by the locking bolt or brought into the assembled state.

Due to the inventive plastic profile, production costs, for example of the floor plates, may be reduced. Further, costs may be avoided by omitting the application of corrosion protection. The installation time may be, for example, 0.4 hours and is thus at least 10 times lower than in conventional installation procedures which require a plurality of screws.

### BRIEF DESCRIPTION OF THE DRAWINGS

The various embodiments will hereinafter be described in conjunction with the following drawing figures, wherein like numerals denote like elements, and:

FIG. 1 shows the connection of floor plates of a floor structure by means of a metallic joint plate.

FIG. 2 shows the connection of two floor plates of a floor structure by means of a profile according to an exemplary embodiment.

FIG. 3 shows an aircraft with a sealing system according to an exemplary embodiment.

FIG. 4 shows a flow chart of a method for connecting a floor structure according to an exemplary embodiment.

### DETAILED DESCRIPTION

The following detailed description is merely exemplary in nature and is not intended to limit the disclosed embodiments or the application and uses thereof. Furthermore, there is no intention to be bound by any theory presented in the preceding background detailed description.

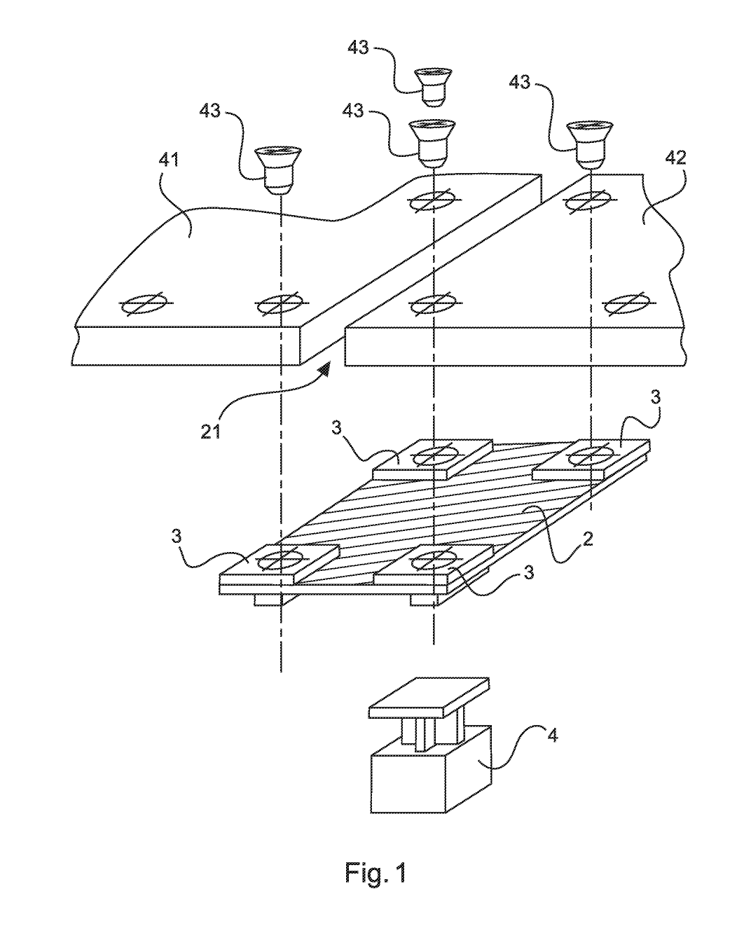

FIG. 1 shows the connection of two floor plates 41, 42 of a floor structure by means of a metallic joint plate 2, wherein the floor plates 41, 42 are attached by means of screws 43 to structural elements or stiffening elements of a vehicle or aircraft which is not shown in FIG. 1. The metallic joint plate 2 comprises a corrosion protection, for example. Between the floor plates 41, 42, a gap 21 is provided. On the metallic joint plate 2, nuts 3, in particular clip nuts, are provided, which are used for receiving the screws 43 or for connecting the joint plate 2 to the floor plates 41, 42. In other words, the floor plates 41, 42 are attached to the metallic joint plate 2 by means of the nuts 3 and the screws 43. The joint plate 2 is used to close or seal the gap 21 between the floor plates 41, 42 and to transmit a sagging of adjacent floor plates. The metallic joint plate 2 is locally reinforced by a supporting unit 4, so that systems being arranged under the floor plates may not be affected or damaged as a result of possible deflections or sagging of the floor plates 41, 42. It may be provided that each of the screws 43 is provided with a corrosion protection or corrosion protection paste, wherein the corrosion protection is applied individually to each screw 43. It is possible that 224 of these screws are provided per plane to connect all the floor plates with each other and to form the floor structure of the aircraft. The metallic joint plate 2 may optionally be provided with a temporary corrosion protection.

The assembly of the floor plates 41, 42 by means of the joint plate 2 may be carried out in multiple steps. Thereby, the metallic joint plate 2 is at first provided with the temporary corrosion protection and subsequently the nuts 3 or clip nuts are pre-assembled on the metallic joint plate 2. In a further step, the joint plate 2 may be pre-assembled subsequently to one of the adjacent floor plates 41, 42 by means of screws 43. Finally, the floor plates 41, 42 may be aligned or adjusted with respect to each other in a further step, and other screws which are not shown in FIG. 1 may be tightened.

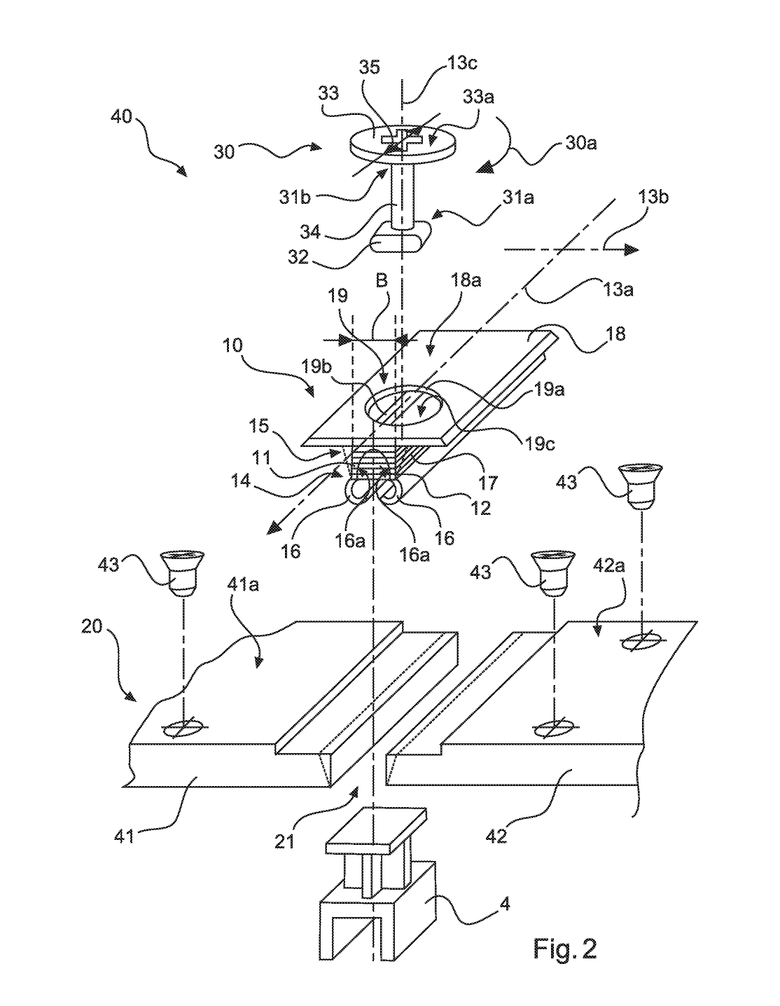

FIG. 2 shows a sealing system 40. Thereby a first floor plate 41 and a second floor plate 42 are connected with each other by means of a profile 10 and by means of a locking bolt 30. Due to the connection of the two floor plates 41, 42 a floor structure 20 results, which floor structure is sealed by the profile 10 and the locking bolt 30. The profile or plastic profile 10 comprises a web 11 and a belt 18 and is, therefore, T-shaped when being viewed in a cross section. The web comprises a recess 12, which is configured for receiving the locking bolt 30, in particular of a shaft 34 of the locking bolt 30. The web 11 comprises a first end 14 and a second end 15. Thereby lips 16 are foldable or pivotally mounted at the first end 14 of the web 11. In particular, the lips 16 are attached in each case elastically and/or rotatable about a point 16a on the web 11. The lips 16 are designed circular or ring-segment-shaped or sickle-shaped and/or protrude beyond lateral surfaces of the web 11 with respect to a transverse direction 13b. In other words, the lips 16 protrude beyond a width B of the web 11, which width B is measured in transverse direction 13b. The lips may thereby be curve-shaped. The profile 10 extends in the longitudinal direction 13a, wherein the cross-section of the profile 10 and the sectional view of the profile 10 is defined by viewing in the longitudinal direction 13a. At the second end 15 of the web 11, the belt 18 of the profile 10 is attached. An opening 19 is provided in the belt 18, wherein the belt has the shape of a profile flange. The opening 19 comprises a circular recess 19a and an elongated hole 19b. Thereby the circular recess 19a of the opening 19 is configured to receive a head 33 of the locking bolt 30, so that a surface 33a of the head 33 of the locking bolt 30 is aligned flush with respect to a surface 18a of the belt 18. This is particularly the case, when the profile 10 is in the assembled state and the head 33 rests on the support surface 19c of the circular recess 19a. Thus, in a mounted or assembled state, the shaft 34 of the locking bolt 30 is located in the elongated hole 19b and therefor in the recess 12 of the web 11, too. In an assembled state, a thickening or an elongated attachment 32 at a first end 31a of the locking bolt 30 pushes the lips 16 apart from each other, so that release of the profile 10 out of the floor structure is prevented. In other words, the profile 10 is inserted in the gap 21 of the floor structure 20 or rather between the two floor plates 41, 42, wherein the lips 16 are pressed towards each other, and when the profile 10 or the web 11 of the profile 10 is completely embedded into the gap 21, the lips 16 push apart from each other due to their flexible elastic design. In this pushed apart state of the lips 16 which is ensured by the locking by means of the elongated attachment 32 of the locking bolt 30, a release of the profile 10 from the floor structure 20 may be prevented. In the region of the lateral surfaces of the web 11, a seal in the form of a foam tape 17 may be provided to provide a sealing of the floor structure 20 in the assembled state of the profile 10. During assembly, the locking bolt 30 of the sealing system 40 is inserted in a vertical direction, that is along a vertical axis 13c, into the plastic profile 10, wherein the plastics profile 10 is already embedded into the floor structure 20. In other words, the profile 10 is locked in the floor structure 20 by inserting the locking bolt 30 into the opening 19. For example, the floor plates 41, 42 may be further fastened with screws 43 to structural elements or stiffening elements of the vehicle or aircraft, which structural elements or stiffening elements are not shown in FIG. 2. It should be noted that FIG. 2 shows a disassembled state or an exploded view of the sealing system 40. In the assembled state, the plastic profile 10 is located between the floor plates 41, 42 and the locking bolt 30 is located in the opening 19, so as to lock the profile 10 in the floor structure 20. A supporting unit 4 prevents a bending or sagging of the floor structure 20 due to stresses or loads, so that systems which are located under the floor structure 20 are not impaired or damaged.

As can also be seen with reference to the dashed lines in FIG. 2, the web 11 may be also wedge-shaped. In particular, the lateral surfaces of the web 11 may be inclined relative to the vertical axis 13c. Thereby, the web 11 may taper towards the first end 14, for example, such that the web 11 has the width B in the region of the first end 14. Accordingly, in this case, the floor plates 41, 42 are formed wedge-shaped in the region of the gap 21, so that the gap tapers from the surfaces 41a, 42a of the two floor plates 41, 42. This can also be seen due to the dashed lines in FIG. 2.

For example, the locking bolt is a locking pin, and may comprise a marker 35 on the surface 33a, which marker makes it possible to recognize whether the profile 10 is located in the floor structure 20 in a locked state. It is noted that locking of the profile 10 in the floor structure 20 is possible by a rotation 30a of the locking bolt 30 about the vertical axis 13c, but also a releasing by turning in the opposite direction is possible. In the mounted state, the surface 18a of the belt 18 may be in alignment or flush with a surface 41a of the first floor plate 41 and/or in alignment or flush with a surface 42a of the second floor plate 42 so that a flat floor structure 20 is formed. Likewise, the surface 33a of the head 33 of the locking bolt 30 may be in alignment or flush with the surfaces 41a, 42a of the floor plates 41, 42 and/or in alignment or flush with the surface 18a of the belt 18. Further, in the assembled state, lips 16 under the floor plates 41, 42 may protrude beyond the floor structure 20.

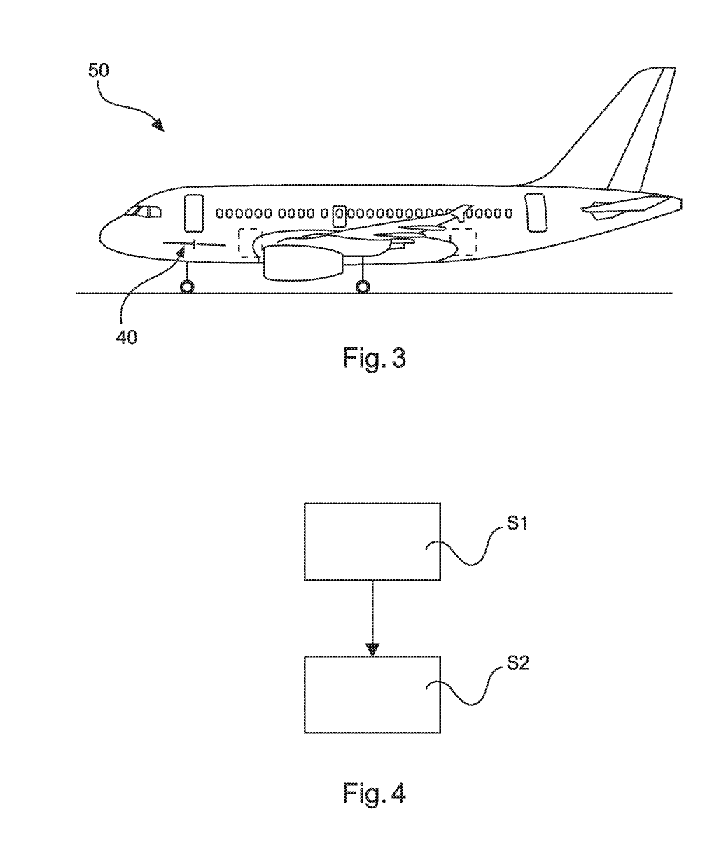

FIG. 3 shows an aircraft 50, in particular a commercial airplane, with a sealing system 40, wherein the sealing system 40 comprises at least two floor plates 41, 42, a profile 10 and a locking bolt 30. The sealing system 40 thus comprises a floor structure 20 which forms the floor structure of a passenger cabin of the aircraft 50.

FIG. 4 shows a flow chart of a method for connecting a floor structure 20. Thereby in a first step S1, the first floor plate 41 and the second floor plate 42 are positioned such that a gap 21 remains between the first floor plate 41 and the second floor plate 42. In a second step S2 of the method, the above-described profile 10 is provided in the gap 21 between the first floor plate 41 and the second floor plate 42, so that the floor structure 20 is sealed.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the embodiment in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the embodiment as set forth in the appended claims and their legal equivalents.

1. A profile for connecting a floor structure, the profile comprising:
a web with a recess extending along a longitudinal direction of the profile;
wherein the web is adapted to engage in a gap in the floor structure, so as to establish the connection of the floor structure;
wherein two elastic lips are arranged at a first end of the web, wherein the two elastic lips extend in the longitudinal direction of the profile, wherein the two elastic lips are configured to prevent a release of the profile out of the gap.

2. The profile of claim 1,
wherein the web comprises a foam tape for sealing the floor structure.

3. The profile of claim 2,
wherein the foam tape completely encompasses at least two opposite sides of the web.

4. The profile of claim 1,
wherein the profile comprises a belt with an opening for receiving a locking bolt, wherein the belt is arranged in a region of a second end of the web.

5. The profile of claim 4,
wherein the opening comprises a circular recess in the belt.

6. The profile of claim 1,
wherein the profile comprises a T-shaped profile.

7. The profile of claim 1,
wherein the elastic lips each comprise a ring segment shaped profile.

8. The profile of claim 1,
wherein each of the lips is arranged rotatable about a respective point at the first end of the web.

9. The profile of claim 1,
wherein in an unloaded state the lips protrude beyond a width (B) of the web with respect to a transverse direction of the profile.

10. A sealing system for a floor structure, the sealing system comprising:
a first floor plate;
a second floor plate;
a profile; and
a locking bolt for attaching the profile in the floor structure,
wherein in an assembled state the profile is arranged at least partially between the first floor plate and the second floor plate as to thereby seal the floor structure;
wherein the profile comprises:
a web with a recess extending along a longitudinal direction of the profile;
wherein the web is adapted to engage in a gap in the floor structure, so as to establish the connection of the floor structure;
wherein two elastic lips are arranged at a first end of the web, wherein the two elastic lips extend in the longitudinal direction of the profile, wherein the two elastic lips are configured to prevent a release of the profile out of the gap.

11. The sealing system of claim 10,
wherein the locking bolt comprises an elongated attachment at a first end, which elongated attachment is configured to press apart the lips in an assembled state of the profile, as to thereby prevent a release of the profile from both of the floor plates.

12. The sealing system of claim 10,
wherein the locking bolt comprises a head at a second end, which head is configured to rest on a support surface of a circular recess if the profile is in the assembled state.

13. The sealing system of claim 10,
wherein a surface of the belt of the profile is aligned in the assembled state to a surface of the first floor plate and to a surface of the second floor plate.

14. An aircraft, comprising a sealing system for a floor structure, the sealing system comprising:
a first floor plate;
a second floor plate;
a profile;
a locking bolt for attaching the profile in the floor structure,
wherein in an assembled state the profile is arranged at least partially between the first floor plate and the second floor plate as to thereby seal the floor structure;
wherein the profile comprises:
a web with a recess extending along a longitudinal direction of the profile;
wherein the web is adapted to engage in a gap in the floor structure, so as to establish the connection of the floor structure;
wherein two elastic lips are arranged at a first end of the web, wherein the two elastic lips extend in the longitudinal direction of the profile, wherein the two elastic lips are configured to prevent a release of the profile out of the gap.

15. A method for connecting a floor structure, comprising the steps of:
positioning a first floor plate and a second floor plate such that a gap remains between the first floor plate and the second floor plate; and
providing of a profile in the gap between the first floor plate and the second floor plate such that the floor structure is sealed;
wherein the profile comprises:
a web with a recess extending along a longitudinal direction of the profile;
wherein the web is adapted to engage in a gap in the floor structure, so as to establish the connection of the floor structure;
wherein two elastic lips are arranged at a first end of the web, wherein the two elastic lips extend in the longitudinal direction of the profile, wherein the two elastic lips are configured to prevent a release of the profile out of the gap.

16. The profile of claim 4, wherein the opening comprises an elongated hole, which extends in the longitudinal direction and forms a connection to the recess in the web.

17. The profile of claim 1, wherein the profile comprises a plastic profile.

18. The sealing system of claim 10, wherein an upper surface of the head of the locking bolt is aligned to the surface of the belt in the assembled state.
